(19) United States
(12) Patent Application Publication
(10) Pub. No.: US 2015/0358693 A1
(43) Pub. Date: Dec. 10, 2015

(54) Method and Apparatus for Producing a Video Production at a Remote Location

(71) Applicants: Cesar Rodriguez, Miami, FL (US); Alain Villalonga, Doral, FL (US)

(72) Inventors: Cesar Rodriguez, Miami, FL (US); Alain Villalonga, Doral, FL (US)

(73) Assignee: LiVoSt Technologies, Inc., Miami, FL (US)

(21) Appl. No.: 14/002,988

(22) PCT Filed: Mar. 2, 2012
(86) PCT No.: PCT/US12/27621

§ 371 Date: Nov. 25, 2014

Related U.S. Application Data
(60) Provisional application No. 61/448,490, filed on Mar. 2, 2011.

(51) Int. Cl. H04N 21/854; H04N 21/2743; H04N 21/231; H04N 21/218; H04N 21/462; H04N 21/61; H04N 21/2665; H04N 21/2187

(52) U.S. Cl. CPC H04N 21/854; H04N 21/2665; H04N 21/2743; H04N 21/2187; H04N 21/2181; H04N 21/4622; H04N 21/6125; H04N 21/6175; H04N 21/231

(57) ABSTRACT

Method and apparatus for producing a video production remotely, in which a controller is adapted to receive inputs from at least two sources. The controller selects which of the sources provides the source for the production at any given time, and transmits the production to a distribution hub for distributing the production to a plurality of recipients, including at least one storage medium.

### CROSS-REFERENCE TO RELATED APPLICATION

This application claims priority from prior-filed U.S. Provisional Application Ser. No. 61/448,490, filed Mar. 2, 2011.

### BACKGROUND OF THE INVENTION

1. Field of the Invention

The invention relates to methods and apparatus for broadcasting events over the Internet and, more particularly, to methods and apparatus for such broadcasting in which a user may direct and produce his or her own broadcast without requiring a great deal of expertise.

2. Description of the Related Art

In the modern age, there is a growing desire to exploit the ever-expanding capabilities of technology to provide new experiences and opportunities to share experiences, such as by sending e-mails, instant messages, tweets and the like. There is also a growing desire to share more extensive and meaningful experiences than can be expressed in short messages or merely in text, such as by photo or video.

Thus, there is a developing base of consumers who enjoy sending video messages to friends, or posting them on shared public sites, such as YouTube. However, thus far, there are only limited and relatively rudimentary technologies available to do so. For example, it is known for individuals to shoot a video and then post it on YouTube for anyone to see, or to send it to friends and family to share the experience depicted, whether it be personal, like a wedding or graduation, or amusing, like the many “cute animal” videos which proliferate over the Internet.

Currently, known technologies do not provide a convenient means for allowing users who are not highly technologically “savvy” to create and distribute high quality productions, particularly live video productions. Many users lack the requisite sophistication to create and distribute such productions on their own, and lack the resources to hire the highly qualified individuals who are capable of creating such productions.

Accordingly, there is a need in the art for new means for allowing individuals, small businesses and other small organizations who lack technical sophistication to create and manage productions, especially video productions, for broadcasting to others.

### SUMMARY OF THE INVENTION

The object of the invention is to provide an improved method for broadcasting an event, and an improved apparatus for implementing the method.

It is a further object of the invention to provide a method and apparatus which will allow users without a high degree of technical sophistication to produce, manage and/or broadcast live events over the Internet.

The invention provides a complete solution to transmit live from anywhere, as long as there is an Internet connection available. The device is the equivalent to a satellite truck but with more advantages, instead of transmitting a broadcast from point A to point B, the broadcast goes directly to a distribution channel, accessible to end users worldwide. The device is small enough to be transported easily and carried anywhere avoiding extensive wiring because it can be placed right at the point of transmission. It can also be used with existing recording device, such as cameras and microphones, and existing displays, as well as existing storage media, whether computer hard drives, flash drives, or any other known storage media.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a flow chart of the inventive method; and

FIG. 2 shows a schematic diagram of the inventive apparatus.

### DETAILED DESCRIPTION OF THE PRESENTLY PREFERRED EMBODIMENTS

The inventive apparatus is composed of the following components that allow for a configuration that will support the highest efficiency and has the highest performance video platform and which delivers many next generation features such as intelligent multi-core technology that applies processing power dynamically when needed most.

The preferred embodiment of the inventive apparatus includes the following components:

| | | |
|---|---|---|
| Drive Bays | External | 5.25″ x 1 |
| | Internal | 3.5″ x 10 |
| Cooling | Rear | 1 x 120 mm rear exhaust fan with wire fan grills |
| System | Bottom | 2 x 92 mm intake fan below hard drive cages |

| | |
|---|---|
| Expansion | 7 |
| Slots | |
| Front I/O | USB2.0 port x 2 |
| | Firewire X 1 |
| | Audio x 2 |
| | Multi-format Media Bay (card reader) x 1 |
| IR Solution | Built-in MCE Certified IR Receiver/Blaster module |
| TFT | 12.1″ screen size |
| Specification | 16:9 ratio |
| | 1920 × 1080 max resolution |
| | 1280 × 800 native resolution |
| | 1 x svga input |
| | 12 v dc input |
| | 9 w power consumption |

Additional components include:

DVD: LG UH12LS28K 12× Blu-Ray Player & DVDRW Combo Drive

CPU: Intel® Core™ i7-2700K 3.50 GHz 8 MB Intel Smart Cache LGA1155 (All Venom OC Certified)

OVERCLOCK-2 EXTREME OVERCLOCK (20% MORE)

FAN: Asetek 510LC Liquid Cooling System 120 MM Radiator & Fan (Enhanced Cooling Performance+Extreme Silent at 20 dBA) (Single Standard 120 MM Fan)

COOLANT: Standard Coolant

HDD:2 TB (2 TB×5) SATA-III 6.0 Gb/s 64 MB Cache 7200 RPM HDD

IEEE_CARD: IEEE 1394 CARD AND DRIVER

IUSB: Built-in USB 2.0 Ports

KEYBOARD: Xtreme Gear Multimedia/Internet USB Keyboard

MB_SRT:60 GB ADATA S511 SATA III 6.0 Gb/s SSD-550 MB/s Read & 500 MB/s Write

MEMORY: 8 GB (4 GB×2) DDR3/1600 MHz Dual Channel Memory (Kingston HyperX)

MOTHERBOARD: [CrossFireX/SLI] GigaByte Z68X-UD3H-B3 Intel Z68 Chipset DDR3 ATX Mainboard w/Lucid Virtu Intel Smart Response Technology & 7.1 Dolby Home Theater Audio, GbLAN, USB3.0, 4× SATA-III RAID, 2 Gent PCIe, 3 PCIe X1 & 2 PCI (All Venom OC Certified)

MOUSE: XtremeGear Optical USB 3 Buttons Mouse

NETWORK: Onboard Gigabit LAN Network

OS: Microsoft® Windows 7 Home Premium (64-bit Edition)

POWERSUPPLY: 850 Watts—Standard Power Supply—SLI/CrossFireX Ready

SOUND: HIGH DEFINITION ON-BOARD 7.1 AUDIO

VIDEO: NVIDIA GeForce GTX 560 2 GB 16× PCIe Video Card (Major Brand Powered by NVIDIA)

VIDEO2: NVIDIA GeForce GTX 560 2 GB 16× PCIe Video Card (Major Brand Powered by NVIDIA)

WNC: 802.11b/g/n 300 Mbps PCI Wireless Adapter Network Card

INPUT VIDEO CARD: OSPREY 460-E FOUR CHANNEL PROFESSIONAL ANALOG VIDEO CARD

AE S21 HTPC Chasis

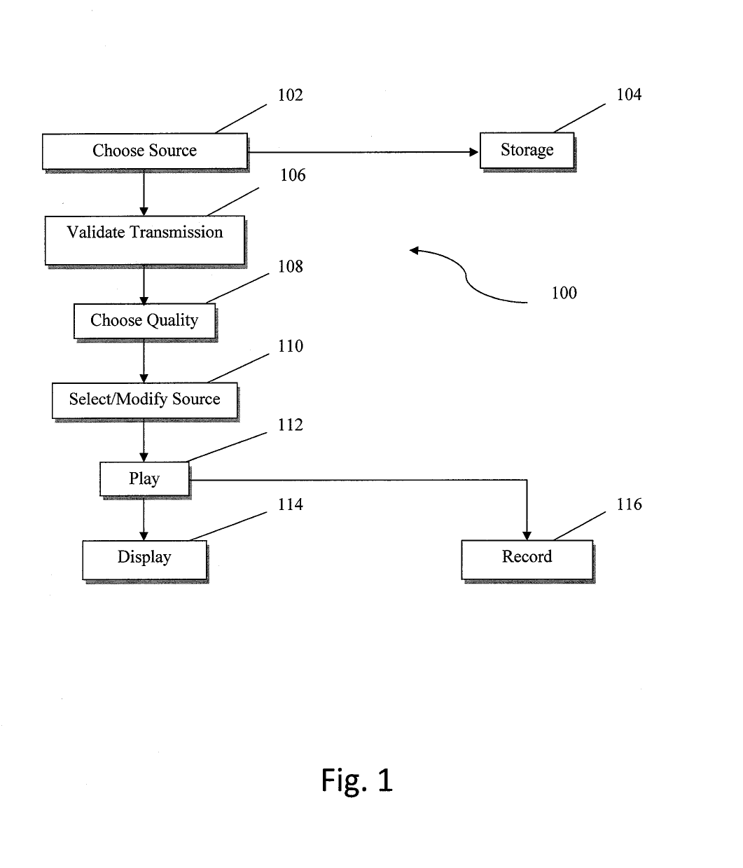

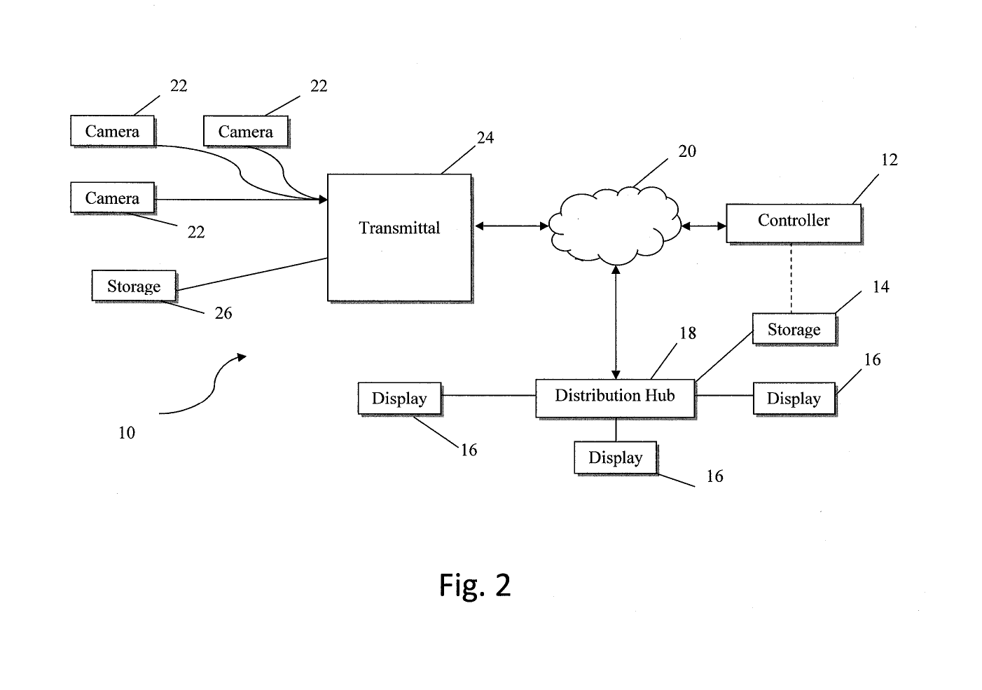

In the following description, the steps are numbered with reference to the flow chart of FIG. 1, while the apparatus is labeled with reference to the schematic of FIG. 2.

In use, the user will first choose 102 to perform one or both of the functions of Archive and Transmit. By selecting Archive, the apparatus 10 will save 104 the file with the whole live transmission, whether in a unique file or in different files. Apparatus 10 can cut an incoming transmission into smaller parts (in a controller 12), from a minute to several hours as chosen by the operator. This is most beneficial when video has to be reused in small segments during a long live coverage without interrupting transmission. In a preferred embodiment, the operator may choose to Archive, by pressing a virtual Archive button on a menu. In this embodiment, a pop-up window will show addressing the location and name of the file of the archive using the current date and time. To change the name, the user may simply rename the root name of the file and press a virtual Change button. Once this option is checked, apparatus 10 will pop up a screen asking for the location where the content will be archived. Preferably, the user then has the ability to save the file to a storage location 14 which may be either local (up to 2 Tb of content, upgradeable to 10 Tb), or on external devices such as HDD, USB flash memory or in a server hosted on the user's network. After the user finishes the transmission, there are have several options for working with the file from that point on, for example on demand delivery, burn DVD's with the whole transmission or uploading in real-time the content as a file-based source.

By selecting Transmit, apparatus 10 preferably connects to a server (not separately shown) to validate 106 through a booking chart whether this device is allowed to transmit for a specific amount of time. Apparatus 10 will create a configuration file that enables controller 12, after the content is received (described below), to transmit it to other output devices 16, either directly or through a distribution hub 18. At this point the user will ensure that controller 12 is properly connected to the Internet 20. This may be accomplished through any suitable means, such as a wired internet connection through an Ethernet port, Wi-Fi internet, Wi-Max internet or via a 3G/4G USB modem (cellular based internet) of any of the providers.

The delivery of the signal works asynchronously, in other words each second of the content is encoded and transmitted locally to the Content Access Point structure (in controller 12), after that the content is sent through the internet 20 on the fly to distribution hub 18. This offers continuity of transmission, and offers redundancy in the sense that if while transmitting the internet signal is lost as soon as it is reestablished the transmission will pick up automatically at the point it cut off so there is no loss in content transmitted.

To Transmit, the user presses a virtual Transmit button, which pops up a window, preferably displaying the user's current IP address and a list of the IP addresses of the various distribution hubs 18 and/or displays 16 to which it is desired to transmit. Preferably, if the user wishes to add an IP address, he or she may simply press over the IP address, and on screen keyboard will appear to allow entry of the desired address. Once validated, the device will be connected to the remote IP addresses where video and audio content will be delivered live.

Next, the user will choose the desired quality of the transmission, by selecting the desired aspect ratio of the output 108.

Every preset output is composed of different threads (qualities) ranging in bitrate and screen resolution, so the end user will enjoy the best possible quality he or she is able to receive through his or her individual internet signal, and always without any interruption (no buffering).

The uploading bandwidth strength that determines the quality also determines how many threads the machine will make. The more bandwidth available the higher the number of threads. This allows for the machine to transmit content even when the internet signal is very low (256 kbps), permitting live transmission from remote places that are not well connected in the sense of strength of the signal.

Each preset is stored in a different file, which allows user to edit the number of threads, the values of the bitrates and screen resolution, etc. resulting in the ability to fulfill particular needs in different scenarios. For the encoding it is preferred to use H264 codec.

These are the technical specifications of each preset:

a. Standard Screen (4×3)

HD 1080p
Bitrate: 5.0 Mbps Screen Resolution: 1900×1200
Bitrate: 3.0 Mbps Screen Resolution: 1600×900
Bitrate: 2.4 Mbps Screen Resolution: 1280×720
Bitrate: 1.3 Mbps Screen Resolution: 704×528
Bitrate: 686 Kbps Screen Resolution: 512×384
Bitrate: 347 Kbps Screen Resolution: 364×272
Bitrate: 199 Kbps Screen Resolution: 276×208
Bitrate: 169 Kbps Screen Resolution: 276×208

HD 720p
Bitrate: 3.0 Mbps Screen Resolution: 1600×900
Bitrate: 2.4 Mbps Screen Resolution: 1280×720
Bitrate: 1.3 Mbps Screen Resolution: 704×528
Bitrate: 686 Kbps Screen Resolution: 512×384
Bitrate: 347 Kbps Screen Resolution: 364×272
Bitrate: 199 Kbps Screen Resolution: 276×208
Bitrate: 169 Kbps Screen Resolution: 276×208

HD 480p
Bitrate: 2.4 Mbps Screen Resolution: 1280×720
Bitrate: 1.0 Mbps Screen Resolution: 640×480
Bitrate: 625 Kbps Screen Resolution: 484×364
Bitrate: 347 Kbps Screen Resolution: 364×272
Bitrate: 199 Kbps Screen Resolution: 276×208
Bitrate: 169 Kbps Screen Resolution: 276×208

Good
Bitrate: 603 Kbps Screen Resolution: 480×360
Bitrate: 347 Kbps Screen Resolution: 364×272
Bitrate: 201 Kbps Screen Resolution: 276×208
Bitrate: 169 Kbps Screen Resolution: 276×208

Regular
Bitrate: 347 Kbps Screen Resolution: 364×272
Bitrate: 201 Kbps Screen Resolution: 276×208
Bitrate: 169 Kbps Screen Resolution: 276×208

Minimal
Bitrate: 347 Kbps Screen Resolution: 364×272
Bitrate: 169 Kbps Screen Resolution: 276×208

Iphone/Ipod
Bitrate: 255 Kbps Screen Resolution: 400×300
Bitrate: 180 Kbps Screen Resolution: 400×300

Ipad

Bitrate: 1.3 Mbps Screen Resolution: 640×480
Bitrate: 802 Kbps Screen Resolution: 640×480
Bitrate: 601 Kbps Screen Resolution: 640×480

b. Wide Screen (16×9)

### HD 1080p

Bitrate: 6.0 Mbps Screen Resolution: 1900×1200
Bitrate: 3.3 Mbps Screen Resolution: 1600×900
Bitrate: 2.5 Mbps Screen Resolution: 1280×720

### Bitrate: 1.7 Mbps Screen Resolution: 904×508

Bitrate: 804 Kbps Screen Resolution: 640×360
Bitrate: 408 Kbps Screen Resolution: 456×256
Bitrate: 202 Kbps Screen Resolution: 320×180
Bitrate: 169 Kbps Screen Resolution: 276×208

### HD 720p

Bitrate: 3.3 Mbps Screen Resolution: 1600×900
Bitrate: 2.5 Mbps Screen Resolution: 1280×720

### Bitrate: 1.7 Mbps Screen Resolution: 904×508

Bitrate: 804 Kbps Screen Resolution: 640×360
Bitrate: 408 Kbps Screen Resolution: 456×256
Bitrate: 202 Kbps Screen Resolution: 320×180
Bitrate: 169 Kbps Screen Resolution: 276×208

### HD 480p

Bitrate: 2.5 Mbps Screen Resolution: 1280×720

### Bitrate: 1.7 Mbps Screen Resolution: 904×508

Bitrate: 740 Kbps Screen Resolution: 612×344
Bitrate: 380 Kbps Screen Resolution: 440×248
Bitrate: 202 Kbps Screen Resolution: 320×180
Bitrate: 169 Kbps Screen Resolution: 276×208

### Good

Bitrate: 804 Kbps Screen Resolution: 640×360
Bitrate: 408 Kbps Screen Resolution: 456×256
Bitrate: 201 Kbps Screen Resolution: 320×180
Bitrate: 169 Kbps Screen Resolution: 276×208

### Regular

Bitrate: 408 Kbps Screen Resolution: 456×256
Bitrate: 201 Kbps Screen Resolution: 320×180
Bitrate: 169 Kbps Screen Resolution: 276×208

### Minimal

Bitrate: 380 Kbps Screen Resolution: 440×248
Bitrate: 169 Kbps Screen Resolution: 276×208

### Iphone/Ipod

Bitrate: 400 Kbps Screen Resolution: 400×224
Bitrate: 200 Kbps Screen Resolution: 400×224

### Ipad

### Bitrate: 1.3 Mbps Screen Resolution: 640×360

Bitrate: 802 Kbps Screen Resolution: 640×360
Bitrate: 601 Kbps Screen Resolution: 640×360

Any of these combinations are provide guidance about the best encoding scenario for an audience. Once a desired combination is selected, apparatus 10 knows how many threads and which resolution and bitrate per thread it is going to transmit to the channel. The presets for the transmission can be configured from 1 to 16 depending on the bandwidth available.

Next, the user must choose the source type 110.

There are generally two source types, Camera or live capture screen and File source. More sources may be added as desired for any particular application.

For live capture, the user may select any one or more available camera 22. Any known source of live video is generically referred to herein as a “camera”, whether or not it may be classically referred to as a “camera”, such as a charge coupled device (“CCD”), video capture device or other device capable of creating an output video stream based upon any type of input. It is expressly contemplated, for example, that an input analog video device which is then coupled to an analog to digital (ND) converter is embraced by the definition of “camera” as used herein.

To add a camera, the user may select the video source, for example, from a drop down menu. Apparatus 10 may also permit the selection of an audio source independently of, or in addition to, a video source.

In the currently preferred embodiment, apparatus 10 may connect up to ten HD cameras, regardless of manufacturer or model. Another additional 10 USB cameras can be also accommodated to be used as live sources. These numbers may be increased or decreased for any particular application as a matter of design choice.

The user may connect an audio source (e.g., a microphone) as well. In the presently preferred embodiment, the user may include up to ten audio sources and should be connected through suitable input ports, such as RCA, XLR, mini XLR, or mini Jack ports. Any live source is composed of a video input device and an audio input device. The dynamic system allows matching one audio source to each video source or one audio source to all cameras. The user may connect multiple cameras to use as live video sources regardless of manufacturers or other technical specifications, such as USB webcams, FireWire (IEEE 1394) digital video cameras, BNC, SDI, HDMI or RCA ports. For ease of reference, each of these solely audio inputs may be considered to be a “camera” 22 as that term is used herein. The outputs of each camera 22 are then output to controller 12, preferably over the Internet 20, through a transmitter 24.

Apparatus 10 may automatically detect any input video or audio device.

In one preferred embodiment, the user may select how to display video whose source dimensions do not match the output dimensions, for example by choosing Letterbox to maintain the aspect ratio and add black bars to the sides of the video, as appropriate, or by choosing instead to Stretch the video to fit the output frame size.

The user can also choose to set up file-based sources to use as or with a live transmission, by selecting any audio or video sources 26 in any supported format.

In one preferred embodiment, the user may program the files sources to act as a continuous playlist, in other words when one finishes the other one starts, and utilize the playlist as a continuous feed.

Once the selections are made, the user may start the transmission 112. The user may any time switch between the different media sources that suit the desired transmission.

In a preferred embodiment, a display associated with controller 12 displays all available sources 22, 24 as they play, and the user may select, via controller 12, which one of the sources 22, 24 is used to make the output, thereby allowing the user to “direct” the output broadcast 114 to displays 16. The transmission as broadcast may also be stored 116 in storage medium 14, either alone or, as is preferable, together with the live capture of each individual camera 22.

Apparatus 10 can receive and monitor multiple incoming streams from different transmitters 24 simultaneously.

Transmission start times can be preprogrammed and feeds received automatically without the need for an operator to synchronize delivery.

in a preferred embodiment, each display 16 has an embedded integrated DVR player that allows the user to follow the transmission live, go back to the beginning, view in slow motion or replay a particular segment as the transmission is happening.

In the above description, the output has been treated as though output as a single file for storage. However, in a preferred embodiment, the output video stream is actually output as a series of successive smaller output files, which will facilitate the subsequent handling of the output, either as a live broadcast or as a stored file. “slicing” the output in this fashion makes it easier to manipulate the files, since it is not necessary to wait for the complete file to download before further actions, such as adding commentary, allowing replay(s) or other video and/or audio manipulation as may be desired by the user.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for controlling a production, the method comprising:
selecting a first source from among a preselected set of sources;
selecting at least one recipient of the production;
receiving a first input from said first source;
selecting a second source from among said preselected set of sources;
receiving a second input from said second source;
transmitting said first input to said least one recipient;
transmitting said second input to said at least one recipient; and
switching between said first and second inputs to selectively transmit one of said first and second inputs to said recipient at any given time;
whereby said at least one recipient receives a transmission which includes portions of said first and second inputs at different times during the production.

2. The method of claim 1, wherein the production is a video production and said first selected source includes a video component.

3. The method of claim 1, wherein said second source includes an audio component.

4. The method of claim 1, wherein said preselected set of sources includes at least one live source and at least one stored source.

5. The method of claim 1, wherein said at least one recipient is at a location remote from at least one of said first and second sources.

6. The method of claim 1, wherein said at least one recipient is a storage location.

7. The method of claim 6, wherein at least one of said first and second sources is located in a second location different from said storage location.

8. The method of claim 1, further comprising the step of slicing the production into smaller segments.

9. An apparatus for controlling a production, comprising:
a first receiver for receiving a first input from a first source from among a preselected set of sources;
a second receiver for receiving a second input from a second source from among said preselected set of sources;
a controller for selectively choosing between said first source and said second source to produce the production as a combination of said first and second inputs;
a transmitter for transmitting the production to at least one recipient;
switching between said first and second inputs to selectively transmit one of said first and second inputs to said recipient at any given time;
whereby said at least one recipient receives a transmission which includes portions of said first and second inputs at different times during the production.

10. The apparatus of claim 9, wherein said first input includes a video component.

10. The apparatus of claim 9, wherein said first input includes an audio component.

11. The apparatus of claim 9, further comprising a storage medium for storing said production.

12. The apparatus of claim 9, further comprising means for slicing the production into smaller segments.

13. The apparatus of claim 9, further comprising a distribution hub, adapted to receive the production, for distributing the production to at least two recipients.

14. The apparatus of claim 11, further comprising means for transmitting each of said first and second sources to said storage medium, whereby the production, and the outputs of said first and second sources are each stored separately in said storage medium.
